(19) United States
(12) Patent Application Publication
(10) Pub. No.: US 2026/0186565 A1
(43) Pub. Date: Jul. 2, 2026

(54) ADAPTIVE ON-BODY INTERFACES AND CONTROLS

(71) Applicant: GOOGLE LLC, Mountain View, CA (US)

(72) Inventors: Ruofei Du, San Francisco, CA (US); David Kim, Zug (CH)

(21) Appl. No.: 19/423,574

(22) Filed: Dec. 17, 2025

Related U.S. Application Data
(60) Provisional application No. 63/739,238, filed on Dec. 27, 2024.

(51) Int. Cl. G06F 3/01; G06F 3/04815

(52) U.S. Cl. CPC G06F 3/013; G06F 3/04815

(57) ABSTRACT

According to at least one implementation, a method includes determining an intent of a user to interact with an application on a wearable device. The method further includes determining an interface for the application based on the intent of the user, and overlaying the interface on a body portion of the user.

### CROSS-REFERENCE TO RELATED APPLICATION

This application claims priority to U.S. Provisional Ser. No. 63/739,238, filed on Dec. 27, 2024, entitled “ADAPTIVE ON-BODY INTERFACES AND CONTROLS”, the disclosure of which is incorporated by reference herein in its entirety.

### BACKGROUND

Wearable extended reality (XR) devices, such as virtual reality (VR) headsets or augmented reality (AR) glasses, are configured to present computer-generated sensory information to a user, often overlaying or replacing the user's perception of their physical environment. These systems can generate immersive virtual or augmented environments for applications including communication, entertainment, and productivity. User interaction within these XR environments is facilitated through various input mechanisms. Some existing systems utilize dedicated physical controllers, which are handheld devices equipped with buttons, joysticks, or trackpads. A user manipulates these controllers, and the physical actions are translated into corresponding inputs within the XR environment. Other systems employ hand-tracking technologies, where cameras or other sensors monitor the position and gestures of a user's hands. In such systems, a predefined set of gestures, for example, a pinching motion of the fingers or a pointing action, can be recognized by the system to trigger specific commands, such as selecting a virtual object or activating a menu.

### SUMMARY

This disclosure describes systems and methods for providing adaptive interfaces for a user of a wearable device. In some implementations, systems and methods are described for generating adaptive interfaces on a user's body within an XR device environment, such as a virtual reality (VR) or augmented reality (XR) environment. Operations can include identifying an intent of a user to interact with an application, which may be based on gaze or hand movement data. Based on the identified intent, a control or interface related to the application is determined, which can be performed using a predictive model, such as a transformer model. An interface that includes the identified control is then displayed on a representation of the user's body, for example, on a virtual hand or arm. This interface can be anchored to the body part so that it moves with the user. The user can operate the control by physically contacting the location on their own body where the virtual control is displayed, providing a tactile experience.

In some aspects, the techniques described herein relate to a method including: determining, based on sensor data of a wearable device and at least one criterion, an intent of a user to interact with an application on the wearable device; determining an interface associated with the application based on the intent of the user; and displaying the interface on a display of the wearable device, the interface being positioned on the display between an eye of the user and a portion of a body of the user.

In some aspects, the techniques described herein relate to a computing system including: a computer-readable storage medium; at least one processor operatively coupled to the computer-readable storage medium; and program instructions stored on the computer-readable storage medium that, when executed by the at least one processor, direct the at least one processor to perform a method, the method including: determining, based on sensor data of a wearable device and at least one criterion, an intent of a user to interact with an application on the wearable device; determining an interface associated with the application based on the intent of the user; and displaying the interface on a display of the wearable device, the interface being positioned on the display between an eye of the user and a portion of a body of the user.

In some aspects, the techniques described herein relate to a computer-readable storage medium having program instructions stored thereon that, when executed by at least one processor, direct the at least one processor to perform a method, the method including: determining, based on sensor data of a wearable device and at least one criterion, an intent of a user to interact with an application on the wearable device; determining an interface associated with the application based on the intent of the user; and displaying the interface on a display of the wearable device, the interface being positioned on the display between an eye of the user and a portion of a body of the user.

The accompanying drawings and the description below outline the details of one or more implementations. Other features will be apparent from the description, drawings, and claims.

### BRIEF DESCRIPTION OF THE DRAWINGS

FIG. 1A illustrates an operational scenario for selecting an interface based on user intent according to an implementation.

FIG. 1B illustrates a side view of an environment according to an implementation.

FIG. 2 illustrates a method of selecting an interface for display based on user intent according to an implementation.

FIG. 3 illustrates an operational scenario for selecting an interface based on user intent according to an implementation.

FIG. 4 illustrates an operational scenario for selecting an interface based on user intent according to an implementation.

FIG. 5 illustrates an operational scenario of moving and reformatting an interface based on user intent according to an implementation.

FIG. 6 illustrates a method of moving and reformatting an interface based on user intent according to an implementation.

FIG. 7 illustrates a computing system to manage the display of an interface on a body of a user according to an implementation.

### DETAILED DESCRIPTION

Wearable XR devices encompass a range of apparatus, such as AR glasses and head-mounted display (HMD) devices, which are configured to generate and present virtual representations of applications and environments to a user. These devices can present virtual reality (VR) environments, which replace a user's physical surroundings with a computer-generated world, or AR environments, which overlay digital information onto the user's view of the real world. The device can include one or more display components to present visual information, processors to render graphical content, and sensors, such as cameras and motion trackers, to monitor the user's position, orientation, and interactions within the physical or virtual space. The system generates and displays representations of applications and their associated user interfaces within the environment for user interaction. Displays in wearable XR devices can use small, high-resolution microdisplays, such as OLED or LCoS, positioned near the user's eyes. Specialized optics, like lenses or waveguides, can then magnify and focus the light from these displays to create an immersive virtual image that appears at a comfortable viewing distance. For augmented reality, see-through waveguides or combiners overlay digital content onto the real world (or physical environment). In contrast, virtual reality devices use opaque displays to replace the user's vision with a computer-generated environment.

To provide input to the wearable devices, the devices can utilize several input mechanisms. In some examples, devices can use physical, external controllers that the user holds. These controllers translate hand movements, button presses, and joystick manipulations into corresponding actions within the virtual space, such as navigation or object manipulation. Another input mechanism is hand movement, where sensors on the XR device can monitor the position and gestures of the user's hands. This allows for direct interaction using a set of gestures, such as pinching a thumb and finger together to select a virtual object or pointing to initiate an action. However, these existing approaches can present technical problems. For example, systems relying on external controllers can require the user to hold separate hardware, which can feel unnatural and may limit free-form hand movements. Additionally, systems relying on basic gesture recognition may lack the precision and contextual adaptability required for more complex tasks like text entry or nuanced interface control.

In some technical solutions, systems and methods are described that address user interaction in XR environments. The approach can include identifying a user's intent to interact with an application and determining a control associated with that application based on the identified intent. An intent can be a predictive determination made by a computing system, based on an analysis of user behavior and application context, that a user is likely to perform an interaction with an application. In some implementations, an intent can be a system-inferred state representing a user's desire to interact with an application, where the state is determined by processing a plurality of input signals including at least one of gaze data, gesture data, or contextual data from the application's user interface. An intent may also refer to a conclusion reached by a system, derived from sensor data and application state, which serves as a trigger to modify the user's interactive environment, such as by generating or displaying a context-specific interface. An interface including the identified control is then displayed on a representation of the user's body within the virtual environment, for example, on the user's hand or arm. This allows the user to interact with application controls by making physical contact with their own body, such as tapping their palm to operate a virtual number pad.

This on-body interface can be generated based on existing two-dimensional user interface elements from web or mobile applications. A machine learning model, such as a transformer model, may be utilized to analyze user interactions, such as gaze or hand gestures, along with application context, to predict and generate an appropriate on-body control interface. For instance, if a user interacts with a text field in a virtual display, a keyboard interface may be generated on the user's palm. The interface can be anchored to the body part, moving with it within the virtual environment, which can provide a more intuitive and tactile user experience.

In some implementations, a wearable device can identify a user's intent to interact with an application or an element within a virtual reality environment. As used herein, an intent of a user to interact with an application refers to a determination, made by the system, that the user is preparing to or desires to provide input to or manipulate an element of the application. This determination is inferred from a combination of user-related data, including but not limited to gaze direction, hand gestures, body posture, and the application context, and serves as a trigger for the system to provide a relevant user interface. The user intent can be determined based on various types of interaction information. For example, the system may utilize one or more sensors, such as image sensors or motion sensors associated with a device, to collect information related to the user. This collected information may include gaze information, which indicates where a user is looking within the virtual environment, and hand motion information, which can be used to recognize specific gestures performed by the user. This hand motion data can be analyzed to determine the position, orientation, and movement of the user's hands over time. The system can then compare sequences of this motion data to a set of stored gesture profiles to recognize a specific action, such as a pinch or a point.

A user's intent may be determined by analyzing one or more user actions within the virtual reality environment. For instance, if a user gazes at a particular user interface element, such as a text input field or a button, for a specified duration, the system may identify this as an intent to interact with that element. Similarly, a user performing a selection gesture, such as a pinching motion or a pointing gesture directed at an application element, can be interpreted as an intent to initiate an interaction. In another example, a user performing a dragging gesture to virtually grab an interface widget and pull it toward a representation (or a passthrough view) of the user's body may indicate an intent to move and utilize the virtual object using an on-body interface.

The determination of user intent can be based on the satisfaction of one or more predefined criteria associated with the collected sensor data. For example, in the case of gaze information, a criterion may be a dwell time threshold. Suppose the system determines that the user's gaze remains fixed on a specific application element for a duration exceeding this threshold. In that case, it can identify an intent to interact with that element. For hand motion, a criterion can be the successful recognition of a gesture from a predefined set. The system may compare the user's hand movements against stored gesture profiles, and if a match is found (e.g., for a pinch or a point), an intent is identified. In another example, the criterion may be a sequence of actions, such as a grab gesture followed by a motion vector directed toward a representation of the user's body. As used herein, a criterion may be a predefined rule or threshold applied to sensor data, wherein satisfaction of the rule or threshold by the sensor data serves as a condition for determining the user's intent. In some examples, a criterion is a specific condition related to user behavior or application state, detected from the sensor data, that must be met to trigger a determination of user intent. A criterion may also be a defined pattern or parameter within the sensor data, where the detection of the pattern or the measurement of the parameter meeting a specified value indicates the user's intent.

In some implementations, the system may identify intent with a higher level of confidence by combining multiple data sources or criteria. For instance, an intent to interact with a text field may be determined when the system detects that the user's gaze has dwelled on the field (satisfying a first criterion) and, concurrently or subsequently, the user performs a selection gesture directed at the same field (satisfying a second criterion). This combination of gaze data, hand gesture data, and contextual information about the application element itself can provide a more robust basis for identifying the user's specific intent.

In some examples, a machine learning model can be configured to facilitate the identification of user intent. The model may be configured (i.e., trained) using interaction data collected during user sessions, such as screenshots of a virtual display, gaze position data, and data describing active user interface elements, for instance, from HyperText Markup Language (HTML) or Extensible Markup Language (XML) code. By processing this data, the model can learn to associate specific user behaviors, such as gazing patterns or gestures, with an intent to interact with certain types of application controls or content. This enables the system to anticipate a user's needs and contextually generate an appropriate on-body interface. A gesture can refer to a specific, recognizable movement or position of a user's body part, such as a hand or finger, that is detected by one or more sensors and interpreted by the system as a command to perform an action. A gesture can include a motion or static pose of a user's body part, which, when identified by a hand-tracking or body-tracking system, corresponds to a predefined input for an application. In some implementations, a gesture is any dynamic or static configuration of a user's body part within the XR environment that the system is configured to recognize and map to a specific user intent or command, such as selecting, moving, or resizing an interface.

In some implementations, the machine learning model can be trained on a dataset that associates one or more input parameters with potential controls or interfaces. In some examples, an input parameter comprises a user's gaze location. In some examples, an input parameter comprises a screenshot or a display on the device (e.g., content including HTML code or XML code). In some examples, an input parameter includes the user's current gesture or body position. The model can be configured on the labeled dataset to associate one or more identified features with a corresponding interface (i.e., controls). In some implementations, the model can be configured to associate feature combinations, including one or more feature combinations that are not expressly provided in the training set, with a corresponding interface. The model can identify the interface based on similarities to the training dataset.

In some examples, after determining a user's intent to interact with a specific application element, a system may display an interface on a virtual representation of the user's body (or a passthrough view of the user's physical body). For example, an interface, which could include one or more controls associated with the application, may be rendered and positioned on a user's hand, arm, or fingertips within a virtual environment. The system can be configured to dynamically resize or reposition the interface to fit a target location on the user's body part. This placement may depend on various factors, such as user preferences or the characteristics of the interface itself. For instance, a numeric keypad interface may be rendered on the palm of a user's hand. In some examples, the system can display the interface as a virtual overlay over the user's body, wherein the user's body is visible via optical or video passthrough on the device. The size and shape of the interface can be updated to reflect the portion of the user.

In some implementations, the system can select a specific portion of the user's body for displaying the interface based on a combination of factors, including the determined user intent and the characteristics of the interface itself. For instance, if the intent involves a simple binary choice (e.g., a ‘yes’/‘no’ prompt), the system may select the user's fingertips as the target location for the corresponding controls. Conversely, if the interface is more complex, such as a numeric keypad or a keyboard, a larger surface like the user's palm or forearm may be selected. A predictive model can be configured to analyze the type and complexity of the required control and map it to a suitable body location, which can also be based on user preferences or ergonomic factors like current body posture.

After selecting the target body portion, the system can utilize its body tracking capabilities to obtain a real-time 3D representation of that part's surface geometry. The rendering engine can then project and conform the interface to the contours of the selected body part. For example, an interface comprising a slider control may be rendered to follow the length and curvature of the user's forearm. This dynamic fitting process ensures that the interface is displayed in a manner that aligns with the physical shape of the body part, preparing it for subsequent interaction.

In some implementations, the system may anchor the interface to the specified location on the body part. When an interface is anchored, it can maintain its position relative to the body part as the user moves within the virtual environment. For instance, an interface anchored to a user's hand will move along with the user's hand. A rendering engine may manage the dynamic adjustment of the interface's position and size to fit the target location. Furthermore, a context-aware model can adjust the layout or functionality of the interface based on the determined intent. For example, if the intent involves entering text, a keyboard layout may be displayed.

As another example, a system can present an interactive number pad on a virtual representation of a user's palm (or the user's physical palm via passthrough) within the VR environment. This virtual number pad can include individual number controls that a user may operate by physically contacting corresponding locations on their actual palm with a finger of their other hand. Such a system can enable a user to discreetly input sensitive information, such as a PIN code or credit card number, by moving a corresponding interface from a primary display to their palm in the VR environment. This approach allows for a tactile interaction experience while using the controls, which can enhance the user's perception of immersion and control within the VR environment.

Additionally, a system can adapt the layout and functionality of the virtual trackpad according to the user's activity context and intent. For example, suppose a user initiates a payment process and interacts with a credit card field on a website displayed in a VR environment. In that case, the system can automatically generate and display a secure number pad on the user's palm. A user can interact with this secure number pad directly on their hand, mimicking interactions with a physical mobile device. This approach can leverage a user's existing familiarity with common user interface elements, making interactions in XR more intuitive. The virtual trackpad can remain anchored to the user's body part within the XR environment, moving with the body part as the user moves, maintaining a consistent relative position.

In another implementation, a system may display an interface, such as a numeric keypad for a payment application, at a fixed location within a virtual reality environment. This interface can be initially anchored in space, meaning its position is independent of the user's movements. A user interface anchored in space is a user interface element, such as a window or object, that possesses a fixed position and orientation within the three-dimensional coordinates of the virtual or augmented reality environment. The location is independent of the user's movements. The user can move toward, away from, or around the interface, but the interface itself remains stationary within the virtual world until explicitly moved or dismissed. This contrasts with a “body-anchored” interface (or anchored to the body), which maintains its position relative to a part of the user's body. In the context of this document, an interface anchored to the body refers to a virtual user interface within an XR environment that is programmatically fixed to a specific location on the user's body (or a virtual representation of it, such as a hand or arm). The key characteristic of an anchored interface is that it maintains its position and orientation relative to that body part, moving cohesively with it as the user moves.

To interact with the keypad, the user can move their hand to a particular position (e.g., with the palm of their hand facing the wearable device). The system may then detect a user gesture, such as a pinching and dragging motion directed at the interface. In response to detecting this gesture, the system may be configured to detach the interface from its fixed location in the virtual space. The system then re-anchors the interface to a portion of the user's body, such as the palm of the user's virtual hand representation. As the user's hand moves within the virtual environment, the re-anchored numeric keypad maintains its position and orientation relative to the user's palm, moving along with the user's hand.

In some implementations, the system can be configured to change the interface displayed on the body portion of the user to reflect the current intent of the user. For instance, in a scenario where a user pulls a numerical entry field toward the palm of their hand, a system may generate a number pad on the user's palm. If the user then interacts with a text entry field, the same system may replace the number pad on the palm with a keyboard interface. In another example, if the user pulls a PIN entry interface toward the palm of their hand during a payment process, a secure number pad may be displayed on the palm of their hand. The displayed interface and the available input elements displayed therewith can be configured to change based on the user's current intent. The current intent can be determined based on the user's gaze, the interactive content displayed for the application, the location of the user's hands, and/or other factors. For example, suppose the user's hands are not positioned to provide input (i.e., receive a tap on the palm of the user's hand). In that case, the system can be configured not to display or receive input from an interface anchored to a portion of the user's body (e.g., the user's hand).

In some examples, the system determines the specific type of input required, whether it's numeric entry, text input, confirmation buttons, or adjustment sliders, and can generate the corresponding on-body interface through a multi-step process. A machine learning model, which can be a transformer in some examples, can predict and output a set of device-specific XML definitions that describe the necessary interface. This XML specifies the interface's components, such as <button> or <slider> elements, and its intended location on the user's virtual body, like the palm, finger, or arm. This XML output is then passed to a rendering engine, which can dynamically create and display the visual interface. The engine repositions and resizes the widget to fit appropriately on the target body part, ensuring a functional and context-aware layout. For example, if a user needs to respond to a yes/no prompt, the system generates XML to render two distinct buttons on their fingertips; similarly, if they need to adjust color settings, it generates sliders along their virtual forearm.

In some examples, rather than generating XML or the visual interface, the device can select an appropriate interface from a set of available options by first analyzing the user's context, which includes the application they are currently using and their potential intent as determined by gaze or gesture tracking. The system maintains a library of available interfaces that are tailored for specific applications or tasks. When a trigger event occurs, such as the user raising their arm into view, the system can evaluate the context and consult the library to choose the most relevant interface. This selection can be based on simple rules or a predictive model that considers the user's past behavior and the most common functions for that specific situation. For example, suppose a user is in a video conferencing application and raises their forearm. In that case, the system can identify video conferencing as the context. The system selects a pre-defined communication control interface from its set, displaying virtual buttons for mute, camera on/off, and raise hand along the arm or hand. As used herein, a set of available interfaces may refer to a collection of pre-defined interface layouts, stored in memory, each associated with a specific application context or user intent, from which the system can select an appropriate interface for display. In some examples, a set of available interfaces is a data structure containing multiple distinct interface definitions, wherein each definition specifies the components and layout of an on-body interface and is indexed or otherwise associated with one or more triggers, such as an application type or a determined user intent. A set of available interfaces may also be a repository of pre-configured user interface templates, wherein the system is configured to query the repository based on the determined user intent to retrieve and render a corresponding interface on the user's body.

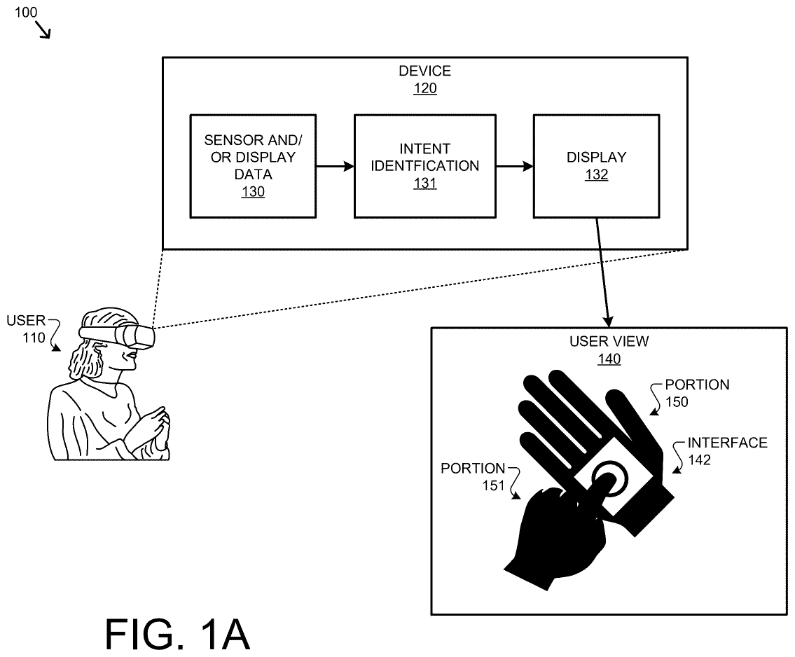

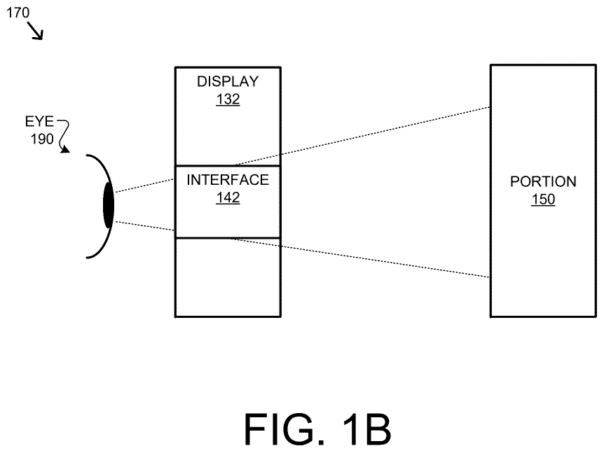

FIG. 1A illustrates an operational scenario 100 for selecting an interface based on user intent according to an implementation. Operational scenario 100 includes user 110, device 120, sensor and/or display data 130, intent identification 131, display 132, and user view 140. User view 140 further includes user portion 150, user portion 151, and interface 142. Device 120 is configured to identify sensor and/or display data 130 and use the data to identify a user intent to interact with an application (i.e., a request to provide input associated with an application). From the intent, intent identification 131 determines an interface 142 to provide to user 110 and provides the interface 142 using display 132. Interface 142 is overlaid and anchored to user portion 150. As used herein, the term interface refers to a virtual construct displayed to a user within an XR environment that enables interaction between the user and an application. The interface comprises one or more interactive controls or input elements that, when actuated by the user, provide input to the application to perform a specific function. An input element is a virtual component of the on-body interface configured to receive a user input when the user physically contacts the particular location on their body where the virtual component is displayed.

In some implementations, sensor and/or display data 130 includes data obtained from the sensors and/or displays on device 120 related to identifying a user's intent to interact with an application on device 120. In some examples, to identify user intent to interact with an application, device 120 may leverage information from one or more sensors. For example, eye movement sensors, which could include one or more image sensors, may be utilized to determine a user's gaze direction, identifying which application or user interface element the user is focusing on. Additionally, hand movement sensors, such as cameras or depth sensors, may be used to recognize specific gestures, postures, or movements of the user's hands as indicative of an intent to select, manipulate, or otherwise interact with a virtual object. Motion sensors, such as accelerometers and gyroscopes, which may be integrated into a head-mounted display or other wearable device, can also provide data related to the user's head or body movements, which can be correlated with interactive intent. Information from these different sensor types may be used individually or in any combination to provide inputs for determining that a user intends to engage with a particular application or control.

In some implementations, sensor and/or display data 130 can include information about the content displayed by device 120. For example, a screenshot of the user's current view within the virtual reality environment may be obtained. Additionally, information from the underlying code of the interface, such as HTML or XML code corresponding to active user interface elements, can be captured. This code can provide details about the type, properties, and arrangement of elements the user is viewing or attempting to interact with. In some implementations, a combination of sensor data (e.g., a gaze determination) can be combined with the displayed content to determine a current focus associated with user 110. As another example, a gesture identified from outward-facing cameras can be associated with an interface displayed by device 120 (e.g., a pinch on a number input field).

From sensor and/or display data 130, device 120 can perform intent identification 131 that identifies the user intent or request to interact with an application. The term intent, as used in this disclosure, signifies a system-identified user state indicating a probable desire to interact with an application. The intent can be determined by processing and analyzing a combination of data streams, including sensor data capturing user actions such as eye movement and hand gestures, and contextual data derived from the application's currently displayed content and underlying structure (e.g., HTML or XML code).

In some implementations, device 120 can process one or more inputs, such as sensor data and contextual information from content displayed to the user. For instance, the system may utilize data from one or more sensors, such as an eye movement sensor of device 120. Gaze data from the sensor can indicate that the user's gaze is directed toward, or lingers upon, a specific user interface element of an application. Device 120 and intent identification 131 may interpret this gaze behavior as an indication of the user's intent to interact with that element or the application associated with it. Similarly, data from hand-tracking sensors can be analyzed to recognize gestures, such as a pointing or pinching motion directed at a virtual object or control element, which can also signal the user's intent to engage with that component.

In some implementations, device 120 and intent identification 131 may further determine user intent by analyzing the content being displayed within a virtual or augmented reality environment. For example, suppose an application displays an input field, such as a field for entering a personal identification number (PIN) or credit card information. In that case, the system can identify the nature of this field from its underlying code, such as its HTML or XML definition. When sensor data indicates the user is focusing on or gesturing toward this specific input field, the system can combine the sensor data with the contextual information from the content to infer a specific intent, such as the user's intent to enter numerical data. This combined analysis enables the system to predict the user's needs and prepare an appropriate interactive tool, such as a virtual number pad, in anticipation of the user's interaction.

In some implementations, intent identification 131 can implement a model, such as a transformer architecture, to process sensor and/or display data 130 and determine the intent of the user and an interface for display by display 132. The model can be configured to take in a variety of inputs, including sensor data like the user's gaze position and hand gestures, as well as display data such as screenshots of the current application view and the underlying user interface (UI) code (e.g., HTML or XML) of the elements the user is interacting with. This combined data is processed and tokenized, allowing the model to identify patterns between a user's interaction with a traditional 2D interface (like a PIN entry field on a webpage) and a corresponding, intuitive on-body interface. Based on this learned context, the model can predict and generate the necessary operation (e.g., VR-specific XML) to render a functional, context-aware interface, such as a number pad or a set of buttons, directly onto the user's hand, arm, or other body part (or a virtual representation thereof).

For instance, if user 110 is viewing at a webpage with a large, scrollable map, the model would process this context to generate a touchpad on their palm. As the user's gaze lingers on the map and they perform an interaction gesture, the system captures a screenshot of the map, the gaze data, and the underlying HTML code of the scrollable element. This combined data is tokenized and fed into the trained transformer model, which recognizes the pattern of interaction with a 2D panning interface. Based on this learned context, the model predicts that a trackpad is the most appropriate on-body control and generates the necessary VR-specific XML code. This code then renders a functional touchpad directly onto the user's virtual palm, enabling them to intuitively navigate the map by simply swiping a finger from their other hand across their palm.

In some implementations, a user may interact with a text entry field within a VR or XR environment. A context-aware model may determine, based on the user's interaction with the text entry field, that the user intends to input text. In response, the system may generate a virtual keyboard as an interface on a virtual representation of the user's palm (or the user's physical palm visible via passthrough on the device). The user can then operate the virtual keyboard by, for example, using the fingers of the opposing hand to contact the locations on their palm that correspond to the keys of the virtual keyboard. This allows for a tactile input method that leverages proprioception and may be more intuitive for users familiar with typing on physical devices.

In some implementations, the device identifies touch input from a finger to a user's palm through the device's integrated cameras and hand monitoring algorithms. Using an inside-out approach, the headset's cameras continuously capture video of the user's hands. This video feed can be processed by a computer vision model that identifies and creates a 3D skeletal mesh of both hands, including the precise position and orientation of the palm and each finger joint. The system can then detect a touch event by determining when the 3D model of a fingertip from one hand comes into proximity with, or intersects, the surface of the 3D model of the opposing palm. By identifying the spatial relationship between these two virtual representations, the device can accurately register not only contact but also gestures, such as taps, swipes, and presses, on the palm's surface. Using the keyboard example, the device can determine when the user contacts a particular key representation on the user's palm.

FIG. 1B illustrates a side view 170 of the environment depicted in operational scenario 100 according to an implementation. Side view 170 includes eye 190 of user 110, display 132, interface 142, and portion 150. Side view 170 provides a technical illustration of the spatial arrangement described in claim 1, wherein the interface 142 is positioned on display 132 between the user's eye 190 and portion 150 of the user's body. Display 132, which can be a component of a wearable XR device such as a waveguide or microdisplay, generates light that forms the virtual interface 142. This light is directed toward the user's eye 190. The system, using data from its sensors, determines the real-time position of the user's body portion 150 (e.g., a hand). The rendering of interface 142 is then strategically placed within the display's output field such that it aligns with the user's line of sight to portion 150.

From the perspective of eye 190, this alignment causes the computer-generated image of interface 142 to appear as if it is overlaid directly onto the physical surface of portion 150. The interface 142 is a virtual construct, and its apparent location on the user's body is a perceptual effect created by projecting its image into the user's field of view at a precise location relative to the tracked body part. The system continuously updates the rendering of interface 142 to maintain this spatial registration as portion 150 moves, thereby creating a stable on-body interface that is anchored to the user. This configuration allows the user to interact with the virtual controls by physically touching the corresponding locations on their own body.

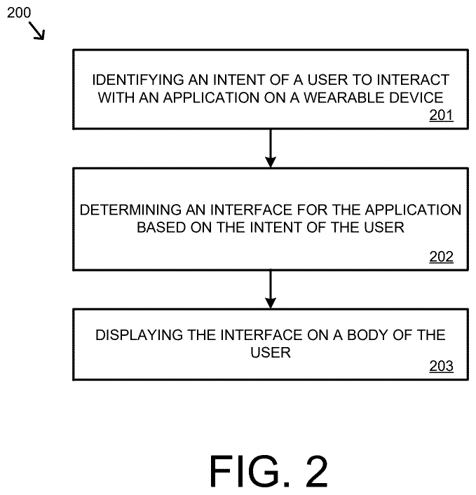

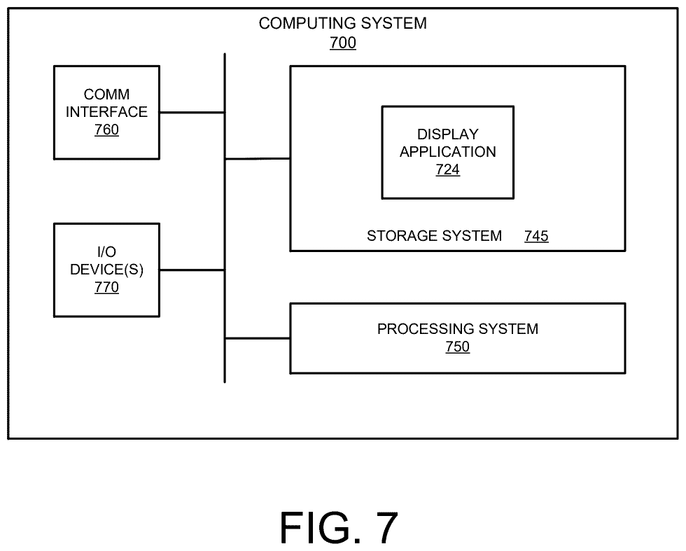

FIG. 2 illustrates method 200 of selecting an interface for display based on user intent according to an implementation. A wearable device can perform method 200 in some examples. In some implementations, a combination of a wearable device and a companion device (e.g., smartphone, tablet, or another computing device) can perform the operations of method 200. In some implementations, method 200 can be performed by computing system 700 of FIG. 7.

Method 200 includes determining an intent of a user to interact with an application on a wearable device at step 201. Method 200 further includes determining an interface for the application based on the intent of the user at step 202 and displaying the interface on a body of the user at step 203.

In some implementations, the user's intent can be determined based on a gesture they perform (i.e., a movement or position of a body portion). For example, a user in an XR environment might perform a pinching gesture on a virtual PIN pad and then drag it towards their own body. This specific combination of a grab gesture followed by a movement towards themselves is interpreted by the system as a clear intent to transfer that interface from the virtual screen onto their palm for more private and tactile interaction. The device can display an interface at a first location (e.g., PIN pad) in space (i.e., not anchored to the physical environment) and, based on the gesture, identify the intent of the user to move the PIN pad to a location on the user's palm. In another example, the user can raise their hand with their palm facing the XR device. In response to identifying the palm, the device can move or locate an interface on the user's hand.

In some implementations, in addition to or in place of the user's movement or body position, the device can use one or more other factors to determine the user's intent. In some examples, the device can monitor where the user's eyes are focused to understand which virtual element currently holds their attention. For instance, if a user's gaze lingers on a specific text input field, the system infers they are preparing to interact with that field. In some examples, the device analyzes the underlying code of the interface, such as the HTML or XML of a UI element, to understand its specific function. For example, by identifying that an element the user is looking at is a <slider>, the system understands the user's probable intent is to adjust a value along a range, not just click a button.

In some implementations, the device can use a combination of the displayed content, user movement (or gestures), and the displayed content to determine the intent of the user. For example, when a user first looks at the PIN entry field on a virtual screen (gaze identification). The system analyzes the underlying UI code to confirm it is a secure number entry field (application context). The user then performs a pinching and dragging gesture toward their own body (hand gesture). The combination of these factors can signal an intent to transfer that PIN pad from the screen onto their palm for more private and tactile interaction.

In some examples, determining user intent can be based on the satisfaction of one or more predefined criteria associated with the collected sensor data. For instance, in the case of gaze information, a criterion may be a dwell time threshold. If the system determines that the user's gaze remains fixed on a specific application element for a duration exceeding this threshold, the system can identify an intent to interact with that element. For hand motion, a criterion can be the successful recognition of a gesture from a predefined set. The system may compare the user's hand movements against stored gesture profiles, and if a match is found (e.g., for a pinch or a point), an intent is identified. In another example, the criterion may be a sequence of actions, such as a grab gesture followed by a motion vector directed toward a representation of the user's body.

In some implementations, the system may identify intent with a higher confidence level by combining multiple data sources or criteria. For instance, an intent to interact with a text field may be determined when the system detects that the user's gaze has dwelled on the field (satisfying a first criterion) and, concurrently or subsequently, the user performs a selection gesture directed at the same field (satisfying a second criterion). This combination of gaze data, hand gesture data, and contextual information about the application element itself can provide a more robust basis for identifying the user's specific intent.

In some examples, a model can be configured to process one or more of the factors mentioned above to identify the user's intent to interact with an application. To consider multiple factors, the model can ingest various data streams, such as gaze position, hand gesture information, screenshots, and the underlying HTML or XML code of the current user interface, and processes them into a unified format. This combined data can be tokenized, creating a sequential representation of the user's complete interaction context. In some examples, the model architecture for this task is a transformer, which is effective at understanding context within sequences. The transformer's encoder processes the tokenized input data to determine the complex relationships between where a user is looking, the gestures they are making, and the functional nature of the UI element they are interacting with. Based on this learned context, the model's decoder then predicts and generates an output sequence of tokens, which translates into the specific code required to render the most appropriate, context-aware interface directly onto the user's body.

In some implementations, the system can determine an interface using simpler, rule-based operations caused by explicit user actions or pre-defined developer instructions. For example, a user could perform a specific, recognized gesture, such as pinching a virtual PIN pad and physically dragging it towards their palm. The system can be programmed to interpret this grab and pull sequence as a direct command to transfer that specific interface. Alternatively, a developer can embed special tags directly into an application's UI code, such as an XML or HTML label like <widget type=“numpad” position=“hands”>, which explicitly tells the system that this element has a pre-defined on-body version, allowing it to be summoned by a simple, non-contextual gesture. In some examples, specific factors like one or more gestures, gaze location, and displayed content from an application can correspond to an interface. For example, when a user raises their hand and faces the palm toward the device, the device can include a rule that generates the display of an interface (e.g., keyboard) based on the gesture or movement from the user.

In some examples, a model can be configured to generate the interface itself by functioning as a sequence-to-sequence transformer, which translates a user's interaction context into renderable code. The model can begin the process by taking a multi-modal input, including screenshots of the application, the user's gaze data, and/or the underlying HTML or XML of the UI element of interest—and converts this diverse data into a unified sequence of tokens. The transformer's encoder then processes this tokenized sequence to build a contextual understanding of the user's intent. Finally, the decoder uses this understanding to predict and generate an entirely new sequence of tokens, which constitutes the specific, device-ready XML code required for the system to display the appropriate, functional widget (i.e., input element), such as a number pad or slider, directly on the user's hand or arm.

In some implementations, the system can select a specific portion of the user's body for displaying the interface based on a combination of factors, including the determined user intent and the characteristics of the interface itself. For instance, if the intent involves a simple binary choice (e.g., a ‘yes’/‘no’ prompt), the system may select the user's fingertips as the target location for the corresponding controls. Conversely, if the interface is more complex, such as a numeric keypad or a keyboard, a larger surface like the user's palm or forearm may be selected. A predictive model can be configured to analyze the type and complexity of the required control and map it to a suitable body location, which can also be based on user preferences or ergonomic factors like current body posture.

After selecting the target body portion, the system can utilize its body tracking capabilities to obtain a real-time 3D representation of that part's surface geometry. The rendering engine can then project and conform the interface to the contours of the selected body part. For example, an interface comprising a slider control may be rendered to follow the length and curvature of the user's forearm. This dynamic fitting process ensures that the interface is displayed in a manner that aligns with the physical shape of the body part, preparing it for subsequent interaction.

The virtual interface is rendered in the three-dimensional space such that it is positioned along the line of sight between the user's viewpoint (i.e., the user's eye) and the surface of the selected body part. From the user's perspective, this causes the interface to appear as a seamless overlay directly on their body. The system continuously updates the position and orientation of the interface to match the user's movements, ensuring that the virtual controls remain visually registered and aligned with the body part as the user moves or changes their viewing angle.

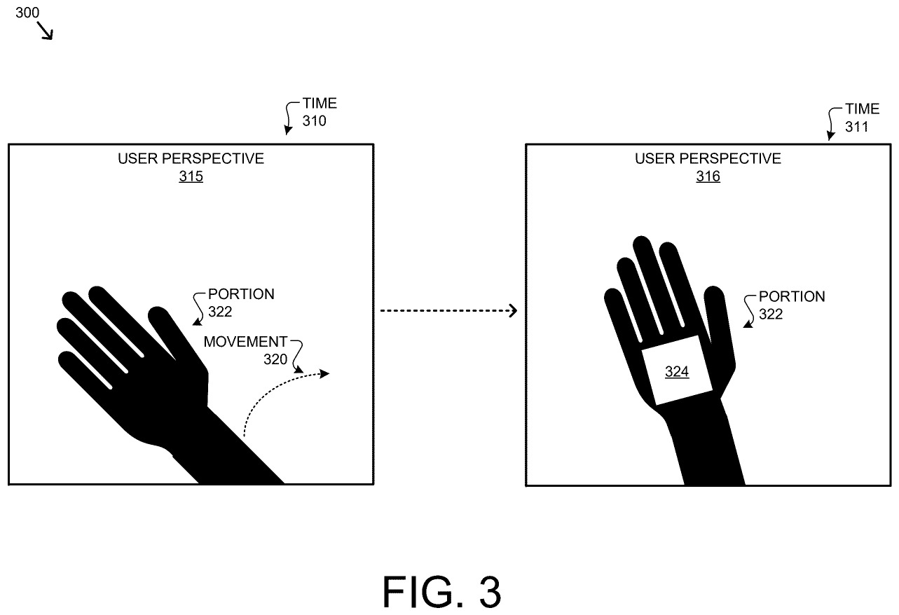

FIG. 3 illustrates an operational scenario of displaying an interface on a user's body according to an implementation. Operational scenario 300 includes time 310 representative of the user perspective 315 at a first time and time 311 representative of the user perspective 316 at a second time. Time 310 includes user movement 320 and body portion 322. Time 311 includes body portion 322 and interface 324. Although demonstrated as a single movement or gesture to trigger the display of interface 324, the user can perform movements or gestures associated with both hands in some examples. Operational scenario 300 can be performed by computing system 700 of FIG. 7 in some implementations.

In operational scenario 300, a user of a wearable device moves their arm (i.e., body portion 322) from a first position to a second position as part of user movement 320. In some system examples, a simple gesture, like a user raising their hand, can be used as a deliberate and intuitive trigger to display a specific interface, such as when it is tied to a user setting, an application, or a common system-level function. For instance, a device can be configured such that raising a left hand with an open palm summons a primary menu, a notifications panel, or a set of quick-access tools like a virtual camera or microphone controls. In this scenario, the gesture acts as a universally available hotkey, independent of the application currently in use, providing the user with a reliable and easily remembered way to access core system functionalities without needing to look away from their current task or use a physical controller. In some examples, the gesture can be tied to a specific application, permitting the system to identify the gesture and application, and determine a corresponding interface to display in association with the application. For example, a first set of input elements can be displayed for a first application, while a second set of elements is displayed for a second application.

In some examples, the device can process the action through a more direct, rule-based recognition system. The one or more cameras on the device can be configured to identify the position and orientation of the user's hands. The system can be programmed with a rule that identifies the specific signature of a hand being raised to a certain height or held in a particular pose. When the incoming tracking data matches this defined signature, the system interprets it as an explicit command to execute the associated action. In this case, the interface 324 is displayed associated with an executing application (including the device operating system in some examples).

Upon successful recognition of the gesture, the system can be configured to render the corresponding interface and anchor it to a relevant body part. For the gesture or movement in operational scenario 300, the interface, such as a settings menu or PIN pad, would logically appear on the user's virtual forearm or the palm of their hand. Once the interface is presented with one or more actionable elements (e.g., virtual buttons, sliders, knobs, etc.), the user can provide input to the interface.

In some implementations, the system can be configured to receive input by using its cameras and hand movement algorithms to create a detailed virtual representation of both hands. The system can monitor the position of the user's fingertips in relation to the surface of their opposite palm, where the interface is displayed. A touch is registered when the software detects that the 3D model of a fingertip has intersected with the 3D model of the palm, allowing it to process the input at that specific location on the virtual interface. For example, if a user sees a virtual Confirm button displayed on the number pad interface on their left palm, they tap that physical location on their palm with their right index finger. The system's hand-tracking cameras register this contact as a valid input, causing the virtual button to depress and submit the information. In submitting the information, an indication of the selection can be provided to the corresponding application.

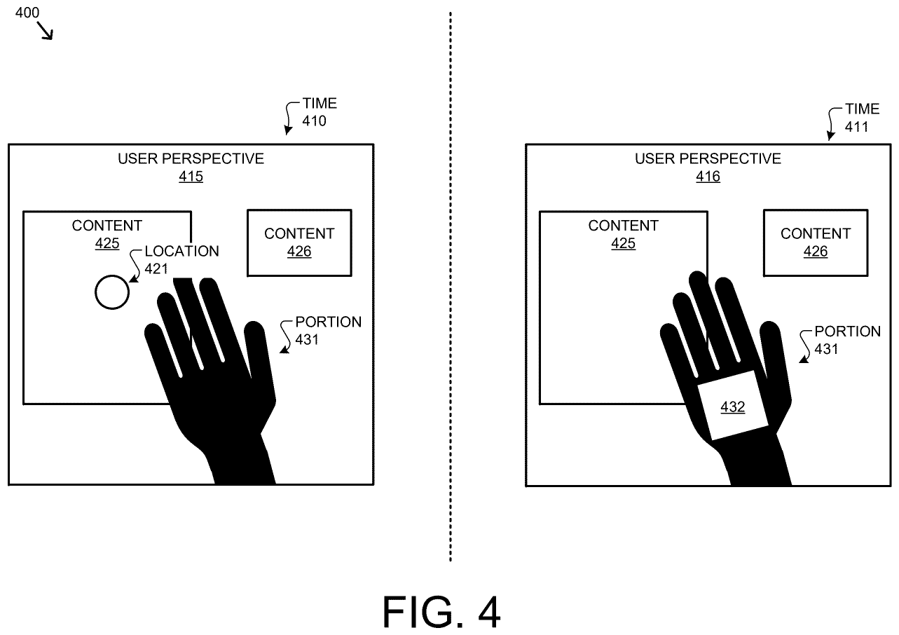

FIG. 4 illustrates an operational scenario 400 of displaying an interface on a user's body according to an implementation. Operational scenario 400 includes time 410 and time 411. Time 410 includes user perspective 415 with gaze location 421, content 425, content 426, and body portion 431. Time 411 includes user perspective 416, body portion 431, and interface 432. Operational scenario 400 can be performed by computing system 700 of FIG. 7 in some implementations.

In operational scenario 400, a system can be configured to use one or more sensors to track the gaze of a user relative to content displayed on a wearable device. In some examples, the system monitors a user's gaze location 421 using a technique called eye monitoring, which is can be accomplished with small, high-speed infrared (IR) cameras mounted inside the headset or glasses, pointing at the user's eyes. These cameras can be paired with IR light-emitting diodes (LEDs) that safely and invisibly illuminate the eyes, creating distinct reflection patterns, known as glints, on the surface of the cornea and making the pupil clearly visible. The cameras capture images of the eyes and these reflection patterns.

In some examples, a stream of images is then processed by computer vision algorithms. These algorithms identify the pupil and the position of the corneal glints. By calculating the geometric relationship and the vector between the pupil's center and these glints, the system can determine the direction the eye is pointing with a high degree of accuracy. This gaze vector is then projected into the 3D virtual environment, allowing the system to calculate the exact point where the user's line of sight intersects with the content being displayed, whether it's a virtual button, a piece of text, or an object in the scene.

Here, gaze location 421 corresponds to content 425 displayed by the device. Based on the gaze location 421 at time 410, the system displays interface 432 on body portion 431 at time 411. By combining gaze and content analysis, a system can infer a user's intent and select an appropriate on-body interface. The device's cameras can first determine the specific UI element the user is focusing on by detecting where their gaze lingers. Once the target element is identified, the system can capture a screenshot of that area and/or the underlying code of that content, such as its HTML or XML tags and properties. This combined data, defining where the user is looking and the functional nature of what they are looking at, can be provided to a machine learning model. The model, which can be configured (i.e., trained) on various interaction patterns, analyzes this context to predict and generate (or identify) the most relevant interface. For example, if the user gazes at an HTML <input type=“password”> field, the model predicts the need for a secure number pad and generates the code to display one on the user's palm. Alternatively, the system can be configured to identify an available interface from a set of available interfaces based on the user's intent. For example, based on the content viewed from the user (e.g., a numerical entry), a number pad or PIN pad can be provided to the user. However, if the content viewed by the user corresponds to text input (e.g., content 426 corresponds to text and content 425 corresponds to numbers), then a keyboard interface can be provided. The system can be configured with a set of available interfaces that can be displayed for the user.

Once interface 432 is displayed at time 411, the device can identify input to interface 432. In some examples, the device can be configured to receive input by using its built-in cameras and algorithms to create detailed, virtual 3D representations of both hands. When an interface is displayed on the user's palm, the system can determine the position of the user's fingertips from the opposite hand relative to that virtual palm surface. A touch input can be registered when the software detects that the 3D model of a fingertip has contact or intersects the 3D model of the palm at the specific location corresponding to a control on the virtual interface. Although this is one example, similar operations can be performed with other types of inputs and controls, such as dials, sliders, or other types of inputs. The system can be configured to identify the controls associated with the user's content and display at least one control as part of an interface for the user.

Although gaze and content are demonstrated as methods to determine user intent, they can be supplemented with user movement or gestures for additional intent determination. In some examples, as a factor in determining intent, hand movement provides an explicit, physical command that clarifies and confirms the interest identified by more passive factors like gaze and content analysis. While gaze tracking can determine what virtual element a user is looking at, and content analysis can understand the function of that element (e.g., it's a number pad), these alone can be ambiguous. A hand movement or gesture can act as a deliberate, active trigger that signals an intention to interact with an application or content displayed by the device.

For example, when a user's gaze lingers on a PIN entry field on a virtual screen, the system can infer a probable interest. However, this inference becomes a high-confidence determination of intent when the user follows up by performing a recognized gesture, such as a pinching motion to select the field and a dragging motion to pull it towards their body. In this sequence, the hand movement can be used as a factor that transforms a passive observation into an actionable command, allowing the system to confidently determine the user's intent to display an interface on the user's hand for interaction.

While the operational scenarios illustrated in FIG. 3 and FIG. 4 depict the interface being displayed on the palm of the user's hand, the system can be configured to display interfaces on various other portions of the user's body. The selection of a specific body part can be determined based on the complexity and function of the required interface. For example, smaller, more straightforward controls may be positioned on the user's fingertips, while larger or more complex interfaces, such as sliders or multi-button panels, could be rendered along the user's forearm.

For instance, in a situation where an application presents a binary choice, such as a confirmation dialog with ‘Yes’ and ‘No’ options, the system may determine that the user's fingertips are a suitable location for these controls. The system could then display a virtual button corresponding to the ‘Yes’ option on the tip of the user's index finger and a second virtual button for the ‘No’ option on the tip of the middle finger. The user could then make a selection by tapping the appropriate fingertip with a finger from their other hand, providing a discrete and tactile method for simple inputs.

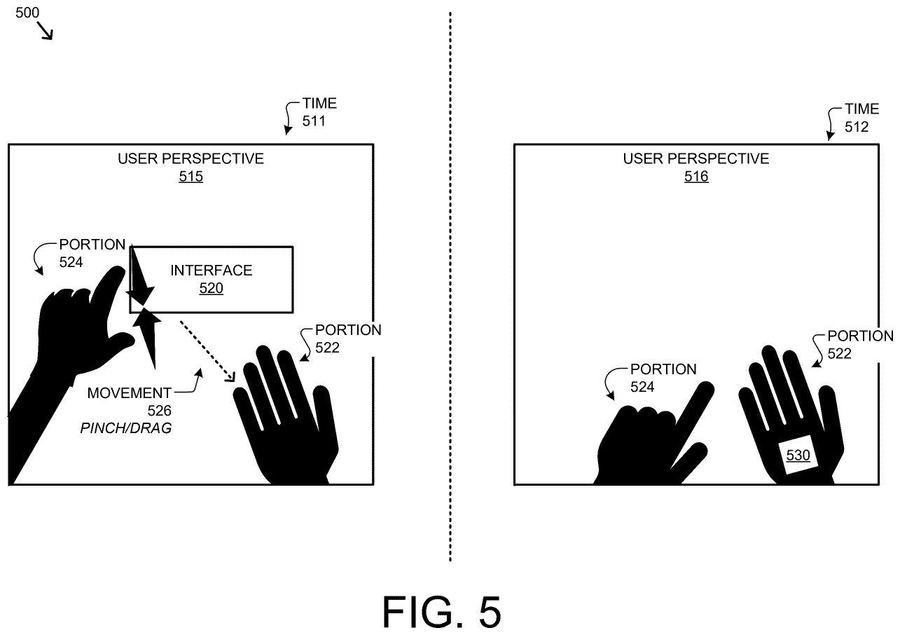

FIG. 5 illustrates an operational scenario 500 of moving an interface between locations according to an implementation. Operational scenario 500 includes time 511 and time 512. Time 511 includes user perspective 515 with interface 520, body portion 522, body portion 524, and movement 526. Time 512 includes user perspective 516 with interface 530, body portion 522, and body portion 524. Interface 530 can be the same as interface 520 or different than interface 520 based on the movement to the user's body portion.

In operational scenario 500, a user is first presented with interface 520. Interface 520 is displayed in space and consists of an interactive panel or object that is not anchored to the user's body. Interface 520 can float in the user's view and can be used to display information, applications, or interactive controls like buttons and sliders. Interface 520 can be moved, resized, or the user can choose to anchor it to a specific location in the virtual world or on their body. In some implementations, the display of interface 520 can be considered a floating window or world-anchored in the virtual space. Rather than being anchored to a physical object, such as a user's body, interface 520 can be positioned in a virtual space associated with the device.

At time 511, the user can provide a movement 526 associated with the user. In operational scenario 500, movement 526 includes body portion 524 performing a pinching gesture in association with interface 520 and moving toward body portion 522. In response to movement 526, the device can be configured to, at time 512, provide an interface 530 that is anchored to a body portion 522.

In some implementations, to move interface 520 to display on body portion 522, the user identifies and selects the desired interface element within the virtual or augmented reality environment. This selection can be accomplished through a natural hand gesture, such as pinching or pointing at interface 520 (e.g., a text box or button) displayed by the wearable device. Once interface 520 is selected, the user can perform a dragging gesture, effectively grabbing interface 520 and pulling interface 520 from its original position toward a chosen location on their body, such as the palm of their hand or forearm. This action signals the user's intent to relocate the interface for on-body use. In some implementations, the user's physical body is visible using optical see-through displays or video see-through displays. In other implementations, a virtual representation of the user's body is visible, which represents the movements and position of the user's physical body.

As the user drags interface 520 toward body portion 522, the system can dynamically adapt the widget for the new location (i.e., can replace a first interface with a new interface). A rendering engine can reposition and resize the interface as interface 530 to fit within body portion 522. In some examples, a context-aware prediction model can adjust the layout and functionality of the interface to correspond to the position on the user's body (e.g., change position, size, or types of inputs available in association with the interface). Interface 530 is then anchored to body portion 522, moving with it in the virtual space, which allows the user to interact with it directly by touching the corresponding location on their physical body. The system registers these physical touches as inputs for an application on the device.

For example, a user browsing a website in a VR environment may need to enter a credit card number to make a purchase. The user can pinch the credit card number field on the virtual web page and drag it toward their palm. As the field approaches, the system transforms it into a full number pad that displays on the user's palm (a physical version of the palm or a virtual version). The user can then tap the numbers on their physical palm with the fingers of their other hand to securely and discreetly enter the required information. In some implementations, once finished, the interface (i.e., interface 530 on the user) can be dismissed or removed from the body portion. The removal can occur when the data is entered, based on a gesture of the user to remove the interface (e.g., a swiping gesture), or based on another input mechanism.

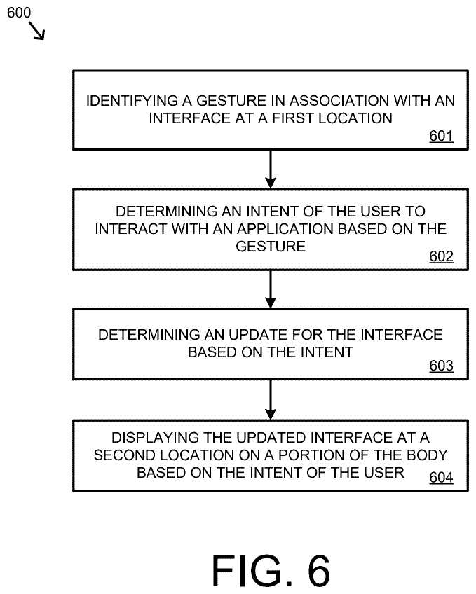

FIG. 6 illustrates method 600 of causing a display of an interface on a body portion according to an implementation. A wearable device can perform method 600 in some examples. In some implementations, a combination of a wearable device and a companion device (e.g., smartphone, tablet, or another computing device) can perform the operations of method 200. In some implementations, method 600 can be performed by computing system 700 of FIG. 7.

Method 600 includes identifying a gesture from a user in association with an interface in a first location at step 601. Method 600 further comprises determining an intent of the user to interact with an application on a wearable device based on the gesture at step 602. Method 600 further includes determining an update for the interface based on the intent at step 603 and displaying the updated interface at a second location on a portion of the body based on the intent of the user at step 604.

For example, a user can interact with an e-commerce website displayed on a large virtual screen floating in front of them within an augmented reality environment. This floating screen is a location in space (or anchored in space), meaning it is a virtual interface positioned in the user's view but not attached to their body. To complete a purchase, the user may need to enter a security code. They initiate the action by performing a pinching gesture on the code entry field on the screen to grab it. The user then performs a dragging gesture, pulling the interface element from the virtual screen towards the open palm of their other hand, which serves as the target location on the user's body (a virtual display area that is anchored to a representation of the user's physical body part and moves with it). In some implementations, the device can be configured to identify the grabbing of the interface (or object) by using a combination of sensors, such as cameras and motion trackers, which are typically integrated into a VR/AR headset. These sensors can feed data into a hand movement system that monitors the position and orientation of the user's hands and fingers in the virtual environment. The system is specifically configured to recognize predefined gestures, such as a pinching motion where the user brings their thumb and forefinger together. When this pinching gesture is performed over a selectable virtual interface or window, the system registers it as a grab action. The device then continues to track the user's hand movement while the pinch is maintained, interpreting this sustained action as a dragging gesture to move the selected element through the virtual space.

As the code entry field approaches the user's hand, the system's rendering engine dynamically transforms it into a secure number pad that is resized to fit neatly onto the user's virtual palm. This number pad can now be anchored to the user's hand, moving cohesively with it in the virtual environment. The user can then interact with the interface by tapping the corresponding locations on their physical palm with a finger from their opposite hand to enter the code discreetly. This method leverages the user's perception and provides tactile feedback, providing a technical effect of a more intuitive and secure interaction than typing on a floating virtual keyboard.

In some implementations, the system can be configured with a defined set of available interfaces. The device can be configured to identify the user's intent by analyzing the application they are using and identifying their gaze or hand gestures. The system can then use this context to choose the appropriate interface. In one method, the system consults a library of pre-defined interfaces, which are created by developers, and selects the interface that matches the current application or task. Alternatively, a more advanced method can use a machine learning model to analyze the 2D interface the user is interacting with and automatically generate the XML code for a custom on-body interface tailored to that specific interaction. For example, if a user is interacting with color adjustment sliders in a photo-editing app, the system's machine learning model would analyze that UI element and generate an interface with two corresponding sliders to be displayed along the user's body portion.

FIG. 7 illustrates a computing system 700 to provide display results according to an implementation. Computing system 700 is representative of any computing system or systems with which the various operational architectures, processes, scenarios, and sequences disclosed herein can be implemented to provide an interface for a user. Computing system 700 may represent a wearable computing device, such as an XR device or smart glasses. Computing system 700 can include multiple computing devices in some examples (e.g., a wearable device and a companion device, such as a smartphone or tablet). Computing system 700 includes storage system 745, processing system 750, communication interface 760, and input/output (I/O) device(s) 770. Processing system 750 is operatively linked to communication interface 760, I/O device(s) 770, and storage system 745. In some implementations, communication interface 760 and/or I/O device(s) 770 may be communicatively linked to storage system 745. Computing system 700 may further include other components, such as a battery and enclosure, that are not shown for clarity.

Communication interface 760 comprises components that communicate over communication links, such as network cards, ports, radio frequency, processing circuitry and software, or some other communication devices. Communication interface 760 may be configured to communicate over metallic, wireless, or optical links. Communication interface 760 may be configured to use Time Division Multiplex (TDM), Internet Protocol (IP), Ethernet, optical networking, wireless protocols, communication signaling, or some other communication format, including combinations thereof. Communication interface 760 may be configured to communicate with external devices, such as servers, user devices, or some other computing device.

I/O device(s) 770 may include computer peripherals that facilitate the interaction between the user and computing system 700. Examples of I/O device(s) 770 may include keyboards, mice, trackpads, monitors, displays, printers, cameras, microphones, external storage devices, and the like.

Processing system 750 comprises microprocessor circuitry (e.g., at least one processor) and other circuitry that retrieves and executes operating software from storage system 745. Storage system 745 may include volatile and nonvolatile, removable, and non-removable media implemented in any method or technology for information storage, such as computer-readable instructions, data structures, program modules, or other data. Storage system 745 may be implemented as a single storage device, but may also be implemented across multiple storage devices or sub-systems. Storage system 745 may comprise additional elements, such as a controller to read operating software from the storage systems. Examples of storage media (also referred to as computer-readable storage media) include random access memory, read-only memory, magnetic disks, optical disks, and flash memory, as well as any combination or variation thereof or any other type of storage media. In some implementations, the storage media may be non-transitory. In some instances, at least a portion of the storage media may be transitory. In no case is the storage media a propagated signal.

Processing system 750 is typically mounted on a circuit board that may hold the storage system. The operating software of storage system 745 comprises computer programs, firmware, or another form of machine-readable program instructions. The operating software of storage system 745 comprises display application 724. The operating software on storage system 745 may include an operating system, utilities, drivers, network interfaces, applications, or other types of software. When read and executed by processing system 750, the operating software on storage system 745 directs computing system 700 to operate as described in the previously described Figures.

The concepts described herein are related to enhancing user interactions with applications in virtual reality and/or extended reality systems. The concepts described herein may be implemented, for example, within virtual reality (VR) or extended reality (XR) systems such as, for example, augmented reality (AR) glasses, head mounted display (HMD) devices, and the like. The concepts may also be used in, for example, any type of computing system.

At least one technical problem with known VR systems is that they often rely on external controllers and/or basic hand gestures. Reliance on external controllers and/or the limitations of basic hand gestures may feel unnatural to a user of such VR systems and/or may negatively impact immersion of the user.

At least some of the technical solutions described herein may be configured to generate one or more interfaces (e.g., user interfaces) that are configured to present a user, for a user of a VR system. Such interfaces may include one or more application controls having input and/or output elements that are likely to be familiar to a user, or are in accordance with one or more predetermined user preferences. Such elements may include, for example, controls from a user interface of a mobile phone, controls from a user interface of a website, or the like, in any combination.

In some implementations, technical solutions described herein may be configured to display one or more interfaces on a portion of the user's body within the VR system, such as virtual representations of the user's hands, arms, legs, or the like, in any combination (or visible portions of the physical body, which can be visible via passthrough). To illustrate, examples of user interfaces may include an interactive number pad, a note-taking tool, application controls such as radio buttons, sliders, track pads, of the like, in any combination.

In some implementations, the technical solutions described herein may be configured to automatically generate one or more interfaces based on an identified intent of the user.

At least one technical benefit of these technical solutions is enhancing a user's experience while interacting with applications in a VR system, for example by identifying the user's intent to interact with an application and automatically displaying a user interface associated with the application on a portion of the user's body. Displaying a user interface on a portion of the user's body may enable a tactile experience while operating one or more application controls via the displayed user interface. Additionally, displaying a user interface on a portion of the user's body may enable enhanced security to application use within a VR system, for example by displaying controls on a user's palm such that one or more inputs of the user via the user interface are blocked or otherwise obscured relative to one or more other participants in the VR system. Additionally, displaying a user interface on a portion of the user's body may enable a user to control one or more elements of the user interface without looking at the user interface (e.g., by employing the user's proprioception). To illustrate, in an example implementation of a technical solution, a user interface displayed on a portion of a user's body may enable the user to tap their wrist to launch a home screen, tap an index finger to copy selected text, tap a ring finger to paste text, and so on, all without the user needing to look at their hand.

An example implementation of the concepts described herein may include a software and/or hardware process that is configured to identify an intent of a user to interact with an application in a virtual reality environment, to identify a control related to the application, and to display an interface that includes the control on a body of the user. The control may be determined based on the user's intent to interact with the application.

In some implementations, the software and/or hardware process may be implemented within a VR or XR system that generates representations of one or more applications within an associated environment for use by a user.

In another example implementation, the software and/or hardware process may be configured to enable a user to copy and/or move all or a portion of an application's user interface to a desired part of the user's body. The software and/or hardware process may be configured to recognize a user gesture as an intent to copy and/or move all or a portion of the user interface. For example, as shown, a user may pinch all or a portion of a user interface, such as a PIN code entry, credit card number entry interface, or the like, of an application in a VR environment and copy and/or move the portion of the user interface to a portion of the user's hand. This may enable the user to discreetly enter sensitive information via an on-body user interface, for example, the palm number pad. This implementation may be desirable, for instance, in a scenario where one or more additional users are present with the user in a VR environment.

In another example, the software and/or hardware process may be configured to enable a user to copy and/or move all or a portion of content displayed within an application to a desired part of the user's body. The software and/or hardware process may be configured to recognize a user gesture as an intent to copy and/or move all or a portion of the application content. For example, a user may pinch a portion of application content and drag it onto a portion of their body, such as the palm of their hand, to save a representation of the content for later use. For example, as shown, the software and/or hardware process may be configured to display a virtual clipboard on a portion of the user's body, such as a palm of their hand. The user may pinch a portion of content from an application and drag it to their palm to make a note related to the content in the virtual clipboard.

In some implementations, the software and/or hardware process may be configured to enable a user to automatically summon one or more interactive widgets, such as PIN pads, note-taking tools, and the like based on an application they use, gaze at, or interact with, in any combination, and make the one or more interactive widgets accessible directly on a portion of the user's body (e.g., the user's hands) in a VR environment. To illustrate, the software and/or hardware process may be configured to enable a user to enter a PIN or add items to a shopping list, by dragging one or more associated widgets from an existing interface onto a portion of a VR representation of the user's body in the VR environment, such as VR representations of the user's hands, for example. In this regard, the software and/or hardware process may be configured to leverage the user's existing familiarity with such interfaces, thereby making VR interactions more intuitive and seamless for the user.

In some implementations, the software and/or hardware process may include a set of XML definitions for an operating system, which may allow one or more widgets to be placed onto a portion of a user's body in VR. In some implementations, the software and/or hardware process may define a set of HTML labels that allow webpages to have such widgets to be placed onto a portion of a user's body in VR.

In some implementations, the software and/or hardware process may use a machine learning model to predict and/or adapt one or more user interfaces of an application, for example, based on what a user is doing in a VR environment.

In some implementations, the software and/or hardware process may be configured to generate a user interface for an application in VR based on an existing 2D interface of the application.

In some implementations, an XML label may allow a developer to create and/or customize widgets (e.g., application user interfaces) specifically for a VR system and/or environment. This may enable the addition of new types of interactions to applications executing in a VR system and/or environment.

In some implementations, the software and/or hardware process may be configured to use machine learning to anticipate a widget that a user might need next, for example based on the context of one or more of the user's activities and/or content that the user is interacting with (e.g., via gazing, pinching, or the like) in a VR system and/or environment. This may reduce the effort required to manage application interfaces in a VR system and/or environment.

In some implementations, the software and/or hardware process may be configured to identify an intent of a user to interact with an application in a VR environment. To illustrate, the software and/or hardware process may be configured to identify the intent of a user to interact with an application based on eye tracking (e.g., gaze tracking), hand tracking (e.g., gesture recognition), or the like, in any combination.

In some implementations, the software and/or hardware process may be configured to leverage hardware and/or software components of a device that a user is using to participate in a VR system and/or environment, such as an HMD. In an example, the software and/or hardware process may be configured to employ one or more image sensors (e.g., cameras), motion sensors, tracking sensors, or the like of a device to collect information related to the user, such as gaze tracking information, hand tracking information, gesture recognition information, or the like, in any combination.

In some implementations, the software and/or hardware process may be configured to identify an intent of a user to interact with an application in a VR environment based on sensed interaction information and/or interaction data that is associated with the user's use of a VR system and/or environment. To illustrate, for one or more (e.g., such as each) user interaction within a VR session, the software and/or hardware process may be configured to sense and/or capture interaction information and/or interaction data. Interaction information and/or interaction data may be generated based on actions the user performs while participating in a VR session.

In some implementations, sources of captures interaction information and/or interaction data may include, for example, one or more screenshots of a current displayed view within the VR session and/or gaze position data. In some implementations, sensed and/or captured interaction information and/or interaction data may be fed into a machine learning model. The interaction information and/or interaction data may help the machine learning model learn, for example, one or more areas of the screen that the user tends to focus on when interacting with different types of UI elements.

In some implementations, sources of captured interaction information and/or interaction data may include HTML information and/or XML code. For example, in some implementations, the software and/or hardware process may be configured to capture HTML information and/or XML code of one or more active UI elements displayed within the VR environment. This may include one or more details such as element type, id, properties, and spatial arrangement, in any combination, which may be useful for understanding a context of one or more interactions of the user within the VR environment.

In some implementations, the software and/or hardware process may be configured to perform data preprocessing and/or tokenization of UI data. For example, the software and/or hardware process may be configured to convert captured HTML and/or XML data into a sequence of tokens. In some implementations, this conversion may include encoding tags, attributes, and/or text content into a format that can be processed by a neural network. For instance, <button id=“submit”>Submit</button> might be tokenized into [“<button>”, “id=”, “submit”, “>Submit</button>”].

In some implementations, the software and/or hardware process may be configured to process data associated with one or more captured screenshots and/or to process collected gaze tracking information. To illustrate, the software and/or hardware process may be configured to process one or more screenshots into a reduced form that may highlight one or more areas of interest, for example based on gaze tracking data. In some implementations, this process may include techniques such as heatmapping to emphasize parts of a UI where the user's gaze lingers, for example.

In some implementations, the software and/or hardware process may be configured to perform machine learning model training and/or transformer model setup. In an example implementation, the software and/or hardware process may be configured to employ a transformer architecture that is known for its effectiveness in handling sequences and/or its ability to capture context within those sequences. Such a transformer model may include an encoder that is configured to process one or more input tokens from the UI data and/or may include a decoder that is configured to predict a sequence of tokens representing the UI XML for the user's hands.

In some implementations, the software and/or hardware process may be configured to provide input to the machine learning model. For example, input to the machine learning model may include, for example, tokenized HTML/XML data and/or processed screenshot data. In some implementations, the machine learning model may output a tokenized form of VR-specific XML definitions for rendering the UI on one or more body parts of the user in the VR environment, such as one or more portions of the user's hands.

In some implementations, the software and/or hardware process may be configured to train the machine learning model. For example, in some implementations, the software and/or hardware process may be configured to use an optimizer capable of efficient training of deep learning models, for instance with hyperparameters tuned based on validation performance. In some implementations, the software and/or hardware process may be configured to divide collected data, such as interaction data, into one or more of a training set, a validation set, and a test set, in any combination, for example to ensure that the machine learning model is robust and generalizes well across different user interactions and UI types.

In some implementations, once the machine learning model is trained, may predict an appropriate UI XML for display on a body part of the user, such as one or both of the user's hands, in the VR environment.

In some implementations, for example by following one or more of the training steps described herein, the machine learning model and/or transformer model may be trained to effectively predict user-centric VR on-body user interfaces for a user, for instance based on one or more interactions of the user with traditional (e.g., 2D) UI elements. A VR on-body user interface may include one or more controls associated with performing actions in an application within a VR environment. The on-body UI may be displayed on a portion of the body of a user, such as a hand of the user in the VR environment, for example. In this regard, the software and/or hardware process may be configured to identify (e.g., select) a control related to an application and to display an interface that includes the control on a body part of the user. The software and/or hardware process may be configured to identify the control based on the intent of the user to interact with the application.

In some implementations, the software and/or hardware process may be configured to enable the anchoring of one or more on-body user interfaces to respective locations on one or more parts of the body of a user within the VR environment. In this regard, an on-body interface, such as a UI, may anchored to a representation of the body of the user (e.g., a VR hand of the user) that is displayed in the VR environment. An anchored on-body UI may remain in a specified location relative to the body part of the user to which it is anchored. For example, if a UI is anchored to a hand of a user in the VR environment, the UI may move along with motion of the user's hand, such that the UI remains in position relative to the user's hand.

It should be appreciated that the technical solutions described herein may enhance the VR experience of a user, for example by making the experience more intuitive. It should further be appreciated that the technical solutions described herein may be configured to leverage a user's existing familiarity, for example with web interfaces and/or application interfaces, which may simplify a learning process associated with VR technologies.

In some implementations, an example user interaction flow of the software and/or hardware process may be initiated with a user putting on a VR device, such as an HMD VR headset and initializing one or more applications within a VR session.

In some implementations, the software and/or hardware process may be configured to, in response to a user initializing one or more applications, automatically load one or more personalized settings and/or UI preferences, for example based on settings in a user's profile. User-defined UI preferences may be configured to control whether and/or how one or more user interfaces may be displayed. To illustrate an example of user UI preferences, the software and/or hardware process may permit one or more types of user interfaces, such as UI number pads, to be displayed and may prevent one or more other types of user interfaces, such as game controllers, from being displayed.

In some implementations, the software and/or hardware process may then set up the VR space, for example a VR environment, such that one or more virtual representations of respective mobile application interfaces and/or web application interfaces are displayed in front of the user within the VR environment.

In some implementations, the user may look at various elements on the virtual display. The software and/or hardware process may track the user's gaze and may highlight one or more elements on the virtual display that the user focuses on, thereby providing visual feedback to the user.

In some implementations, when the user wants to interact with a specific element, such as a text box or a button, the user may perform a selection gesture, such as pinching, pointing, or the like, to initiate interaction.

In some implementations, to move an interaction widget (e.g., a number pad, a text box, or the like) to a part of their body (e.g., one of their hands) in the VR environment, the user may perform a dragging gesture. In this regard, the user may virtually grab the widget from its original position in the virtual display and pull it toward their hand.

In some implementations, as the widget approaches the user's hand, a widget rendering engine of the software and/or hardware process may dynamically reposition and/or resize the widget to fit on a target location on the user's hand, such as the palm of the user's hand, the back of the user's hand, or another location. In some implementations, the placement location of the widget on the user's hand may depend, for example, on one or more user preferences, widget characteristics, or similar factors.

In some implementations, a context-aware prediction model may automatically adjust a functionality and/or a layout of the widget, for example, based on a context. For instance, if the user pulls a text entry field toward a palm of a hand of the user, the software and/or hardware process may generate a keyboard on the palm of the user's hand. In another example, if the user pulls a PIN entry interface toward the palm of the user's hand during a payment process, a secure number pad may be displayed on the palm of the user's hand.

In some implementations, the user may interact with a widget (e.g., an on-body UI) displayed on their hand, either by directly entering information or by making selections by pressing the respective locations on the palm where operable elements (e.g., controls) of the widget are displayed. In this regard, the software and/or hardware process may be configured to mimic, within the VR environment, a familiar user experience outside of the VR environment, such as interacting with a similar application on a physical mobile device, for example.

In some implementations, the software and/or hardware process may be configured such that once a user interaction is complete, for instance, once a user submits a form, finalizes a payment, or the like, the widget can be dismissed, for example, in response to the user making a swiping gesture with one or both hands within the VR environment.

In some implementations, one or more widgets may remain displayed, for example, on a hand of the user, for continued use, or may be moved back to the virtual screen, for instance, if the user decides to reposition one or more widgets for later use.

In some implementations, the software and/or hardware process may be configured to monitor one or more of the user's gaze, positions of the user's hands, and gestures, for instance, to anticipate further needs of the user within the VR environment.

In some implementations, the software and/or hardware process may be configured to enable a user to engage with one or more other elements on the virtual screen, to pull one or more additional widgets to be displayed on respective parts of the user's body, or to adjust one or more currently displayed widgets, in any combination as desired by the user.

In some implementations, the software and/or hardware process may be configured such that once the user is done participating in the VR environment, the user may close the application through a VR interface element and/or by removing the VR device. The software and/or hardware process may be configured to save any changes and/or preferences of the user for future VR sessions.

Below are example clauses associated with the present disclosure. The described clauses should not be considered exhaustive.

Clause 1. A method comprising: determining, based on sensor data of a wearable device and at least one criterion, an intent of a user to interact with an application on the wearable device; determining an interface associated with the application based on the intent of the user; and displaying the interface on a display of the wearable device, the interface being positioned on the display between an eye of the user and a portion of a body of the user.

Clause 2. The method of clause 1, wherein the interface includes an input element, and wherein the input element is operable by the user physically contacting a location on the body where the input element is displayed.

Clause 3. The method of clause 1, wherein the sensor data comprises motion data, wherein determining the intent of the user based on the sensor data and the at least one criterion comprises identifying the intent of the user based on the motion data satisfying the at least one criterion associated with a gesture from the user in association with the interface at a first location, and wherein displaying the interface on the display comprises displaying the interface at a second location on the display different from the first location.

Clause 4. The method of clause 3, wherein the first location is anchored in space and the second location is anchored to the body of the user.

Clause 5. The method of clause 1, wherein the sensor data comprises motion data associated with the portion of the user, and wherein the at least one criterion comprises a position for the portion of the user.

Clause 6. The method of clause 5, wherein the position comprises a first position and wherein the portion comprises a first portion, wherein the method further comprises: identifying a second position of a second portion of the user, wherein determining the intent of the user is further based on the second position of the second portion of the user.

Clause 7. The method of clause 1, wherein determining the interface for the application based on the intent of the user comprises: identifying a set of available interfaces; and selecting the interface from the set of available interfaces.

Clause 8. The method of clause 1, wherein the sensor data comprises gaze data.

Clause 9. A computing system comprising: a computer-readable storage medium; at least one processor operatively coupled to the computer-readable storage medium; and program instructions stored on the computer-readable storage medium that, when executed by the at least one processor, direct the at least one processor to perform a method, the method comprising: determining, based on sensor data of a wearable device and at least one criterion, an intent of a user to interact with an application on the wearable device; determining an interface associated with the application based on the intent of the user; and displaying the interface on a display of the wearable device, the interface being positioned on the display between an eye of the user and a portion of a body of the user.

Clause 10. The computing system of clause 9, wherein the interface includes an input element, and wherein the input element is operable by the user physically contacting a location on the body where the input element is displayed.

Clause 11. The computing system of clause 9, wherein the sensor data comprises motion data, wherein determining the intent of the user based on the sensor data and the at least one criterion comprises identifying the intent of the user based on the motion data satisfying the at least one criterion associated with a gesture from the user in association with the interface at a first location, and wherein displaying the interface on the display comprises displaying the interface at a second location on the display different from the first location.

Clause 12. The computing system of clause 11, wherein the first location is anchored in space and the second location is anchored to the body of the user.

Clause 13. The computing system of clause 11, wherein the sensor data comprises motion data associated with the portion of the user, and wherein the at least one criterion comprises a position for the portion of the user.

Clause 14. The computing system of clause 13, wherein the position comprises a first position and wherein the portion comprises a first portion, wherein the method further comprises: identifying a second position of a second portion of the user, wherein determining the intent of the user is further based on the second position of the second portion of the user.

Clause 15. The computing system of clause 9, wherein determining the interface for the application based on the intent of the user comprises: identifying a set of available interfaces; and selecting the interface from the set of available interfaces.

Clause 16. The computing system of clause 9, wherein the sensor data comprises gaze data.

Clause 17. A computer-readable storage medium having program instructions stored thereon that, when executed by at least one processor, direct the at least one processor to perform a method, the method comprising: determining, based on sensor data of a wearable device and at least one criterion, an intent of a user to interact with an application on the wearable device; determining an interface associated with the application based on the intent of the user; and displaying the interface on a display of the wearable device, the interface being positioned on the display between an eye of the user and a portion of a body of the user.

Clause 18. The computer-readable storage medium of clause 17, wherein the interface includes an input element, and wherein the input element is operable by the user physically contacting a location on the body where the input element is displayed.

Clause 19. The computer-readable storage medium of clause 17, wherein the sensor data comprises motion data, wherein determining the intent of the user based on the sensor data and the at least one criterion comprises identifying the intent of the user based on the motion data satisfying the at least one criterion associated with a gesture from the user in association with the interface at a first location, and wherein displaying the interface on the display comprises displaying the interface at a second location on the display different from the first location.

Clause 20. The computer-readable storage medium of clause 17, wherein the sensor data comprises motion data associated with the portion of the user, and wherein the at least one criterion comprises a position for the portion of the user.

In accordance with aspects of the disclosure, implementations of various techniques and methods described herein may be implemented in digital electronic circuitry, or in computer hardware, firmware, software, or in combinations of them. Implementations may be implemented as a computer program product (e.g., a computer program tangibly embodied in an information carrier, a machine-readable storage device, a computer-readable medium, a tangible computer-readable medium), for processing by, or to control the operation of, data processing apparatus (e.g., a programmable processor, a computer, or multiple computers). In some implementations, a tangible computer-readable storage medium may be configured to store instructions that when executed cause a processor to perform a process. A computer program, such as the computer program(s) described above, may be written in any form of programming language, including compiled or interpreted languages, and may be deployed in any form, including as a standalone program or as a module, component, subroutine, or other unit suitable for use in a computing environment. A computer program may be deployed to be processed on one computer or on multiple computers at one site or distributed across multiple sites and interconnected by a communication network.

While certain features of the described implementations have been illustrated as described herein, many modifications, substitutions, changes, and equivalents will now occur to those skilled in the art. It is, therefore, to be understood that the appended claims are intended to cover all such modifications and changes as fall within the scope of the implementations. They have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

It will be understood that, in the foregoing description, when an element is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element, there are no intervening elements present. Although the terms directly on, directly connected to, or directly coupled to may not be used throughout the detailed description, elements that are shown as being directly on, directly connected or directly coupled can be referred to as such. The claims of the application, if any, may be amended to recite exemplary relationships described in the specification or shown in the figures.

As used in this specification, a singular form may, unless definitively indicating a particular case in terms of the context, include a plural form. Spatially relative terms (e.g., over, above, upper, under, beneath, below, lower, and so forth) are intended to encompass different orientations of the device in use or operation in addition to the orientation depicted in the figures. In some implementations, the relative terms above and below can, respectively, include vertically above and vertically below. In some implementations, the term adjacent can include laterally adjacent to or horizontally adjacent to.

What is claimed is:

1. A method comprising:
determining, based on sensor data of a wearable device and at least one criterion, an intent of a user to interact with an application on the wearable device;
determining an interface associated with the application based on the intent of the user; and
displaying the interface on a display of the wearable device, the interface being positioned on the display between an eye of the user and a portion of a body of the user.

2. The method of claim 1, wherein the interface includes an input element, and wherein the input element is operable by the user physically contacting a location on the body where the input element is displayed.

3. The method of claim 1,
wherein the sensor data comprises motion data,
wherein determining the intent of the user based on the sensor data and the at least one criterion comprises identifying the intent of the user based on the motion data satisfying the at least one criterion associated with a gesture from the user in association with the interface at a first location, and
wherein displaying the interface on the display comprises displaying the interface at a second location on the display different from the first location.

4. The method of claim 3, wherein the first location is anchored in space and the second location is anchored to the body of the user.

5. The method of claim 1, wherein the sensor data comprises motion data associated with the portion of the user, and wherein the at least one criterion comprises a position for the portion of the user.

6. The method of claim 5, wherein the position comprises a first position and wherein the portion comprises a first portion, wherein the method further comprises:
identifying a second position of a second portion of the user,
wherein determining the intent of the user is further based on the second position of the second portion of the user.

7. The method of claim 1, wherein determining the interface for the application based on the intent of the user comprises:
identifying a set of available interfaces; and
selecting the interface from the set of available interfaces.

8. The method of claim 1, wherein the sensor data comprises gaze data.

9. A computing system comprising:
a computer-readable storage medium;
at least one processor operatively coupled to the computer-readable storage medium; and
program instructions stored on the computer-readable storage medium that, when executed by the at least one processor, direct the at least one processor to perform a method, the method comprising:
determining, based on sensor data of a wearable device and at least one criterion, an intent of a user to interact with an application on the wearable device;
determining an interface associated with the application based on the intent of the user; and
displaying the interface on a display of the wearable device, the interface being positioned on the display between an eye of the user and a portion of a body of the user.

10. The computing system of claim 9, wherein the interface includes an input element, and wherein the input element is operable by the user physically contacting a location on the body where the input element is displayed.

11. The computing system of claim 9,
wherein the sensor data comprises motion data,
wherein determining the intent of the user based on the sensor data and the at least one criterion comprises identifying the intent of the user based on the motion data satisfying the at least one criterion associated with a gesture from the user in association with the interface at a first location, and
wherein displaying the interface on the display comprises displaying the interface at a second location on the display different from the first location.

12. The computing system of claim 11, wherein the first location is anchored in space and the second location is anchored to the body of the user.

13. The computing system of claim 11, wherein the sensor data comprises motion data associated with the portion of the user, and wherein the at least one criterion comprises a position for the portion of the user.

14. The computing system of claim 13, wherein the position comprises a first position and wherein the portion comprises a first portion, wherein the method further comprises:
identifying a second position of a second portion of the user,
wherein determining the intent of the user is further based on the second position of the second portion of the user.

15. The computing system of claim 9, wherein determining the interface for the application based on the intent of the user comprises:
identifying a set of available interfaces; and
selecting the interface from the set of available interfaces.

16. The computing system of claim 9, wherein the sensor data comprises gaze data.

17. A computer-readable storage medium having program instructions stored thereon that, when executed by at least one processor, direct the at least one processor to perform a method, the method comprising:
determining, based on sensor data of a wearable device and at least one criterion, an intent of a user to interact with an application on the wearable device;
determining an interface associated with the application based on the intent of the user; and
displaying the interface on a display of the wearable device, the interface being positioned on the display between an eye of the user and a portion of a body of the user.

18. The computer-readable storage medium of claim 17, wherein the interface includes an input element, and wherein the input element is operable by the user physically contacting a location on the body where the input element is displayed.

19. The computer-readable storage medium of claim 17,
wherein the sensor data comprises motion data,
wherein determining the intent of the user based on the sensor data and the at least one criterion comprises identifying the intent of the user based on the motion data satisfying the at least one criterion associated with a gesture from the user in association with the interface at a first location, and
wherein displaying the interface on the display comprises displaying the interface at a second location on the display different from the first location.

20. The computer-readable storage medium of claim 17, wherein the sensor data comprises motion data associated with the portion of the user, and wherein the at least one criterion comprises a position for the portion of the user.
